(19) United States
(12) Patent Application Publication
(10) Pub. No.: US 2001/0010852 A1
(43) Pub. Date: Aug. 2, 2001

(54) ELONGATED LIQUID ABSORBENT PAD AND SYSTEM FOR COLLECTING LEAKS AND SPILLS

(76) Inventors: JAMES DENNIS COTTON, MARIETTA, GA (US); JAMES JAY TANNER, WINNECONNE, WI (US); JEFFREY DEAN LINDSAY, APPLETON, WI (US)

Correspondence Address: KARL V SIDOR, KIMBERLY-CLARK WORLDWIDE INC, PATENT DEPT, 401 NORTH LAKE ST, NEENAH, WI, 54956

(21) Appl. No.: 09/119,602

(22) Filed: Jul. 22, 1998

Related U.S. Application Data
(60) Provisional application No. 60/054,250, filed on Jul. 30, 1997.

(51) Int. Cl. B32B 3/00; B32B 5/02; B32B 9/00; B32B 1/04; B32B 3/02

(52) U.S. Cl. 428/68; 428/74; 428/76

(57) ABSTRACT

An elongate, liquid absorbent pad for controlling liquids and/or collecting liquid spills and leaks. The pad includes: (1) an elongate, substantially coherent, liquid absorbent structure formed of a matrix of fibrous material having a substantially polygonal cross-section; (2) a flexible, liquid permeable cover enclosing the absorbent core, and; (3) at least one fastening means positioned on at least a portion of the liquid permeable cover. The fastening means may be a hook and loop fastening system, a magnetic fastening system, clips, snaps, fasteners, eyes, hooks, pins or the like. The fastening means may also be an adhesive layer or a combination of mechanical systems and adhesives. The fastening means is adapted to secure the absorbent pad or sock to a surface, to another absorbent pad, or to a device for wiping up liquid.

### FIELD OF THE INVENTION

This invention generally relates the field of absorbent pads used to control industrial leaks and spills. More particularly, this invention relates to the field of high capacity liquid absorbent pads used to control industrial leaks and spills, methods of manufacturing liquid absorbent structures, and systems for collecting leaks and spills.

### SUMMARY OF THE INVENTION

The present invention is directed to an elongate, liquid absorbent pad or sock for controlling liquids and/or collecting liquid spills and leaks. The pad or sock includes: (1) an absorbent core which may be an elongate, substantially coherent, liquid absorbent structure formed of a matrix of fibrous material having a substantially polygonal cross-section or a core formed from loose absorbent material; (2) a flexible, liquid permeable cover enclosing the absorbent core and which may optionally extend beyond the ends of the absorbent core to form tabs, and; (3) at least one fastening means positioned on at least a portion of the liquid permeable cover. The fastening means may be one or more mechanical fastening means or one or more adhesives or combinations thereof. The mechanical fastening means may be a hook and loop fastening system, a magnetic fastening system, clips, snaps, fasteners, eyes, hooks, pins, buttons or the like. The mechanical fastening means is adapted to secure the absorbent pad or sock to a surface, to another absorbent pad or sock, or to a device for wiping up liquid.

According to an aspect of the invention, large leaks can be controlled by damming, directing, or diking the leak and small leaks can be controlled by wiping or scouring. The absorbent pad or sock may be used on stationary or mobile (e.g., flowing or trickling) leaks and spills.

An important feature of the invention is that the substantially coherent, liquid absorbent structure is formed of a matrix of fibrous material and has a substantially polygonal cross section. That is, the plane of the cross section should have at least four sides (i.e., a quadrilateral cross section), although cross-sections defining more than four sides are contemplated. Desirably, the substantially coherent, liquid absorbent structure has a substantially rectangular cross section. Even more desirably, the substantially coherent, liquid absorbent structure has a rectangular cross section and is elongate.

The substantially coherent, liquid absorbent structure is a matrix of fibrous material which may be a batt of fibrous material. Alternatively and/or additionally, the substantially coherent absorbent structure may include discrete layers of fibrous material. These discrete layers may be separately formed in a web or batt forming process or may be layers of webs such as, for example, meltblown webs, spunbond webs, bonded-carded webs, hydraulically entangled webs and combinations of these materials.

In embodiments of the invention, it is contemplated that the substantially coherent, liquid absorbent structure may be a foam material including, but not limited to, a coherent foam structure, particles of polymeric foams, layers of foams suitable for absorbing water and/or oil. The foam material is desirably an open cell foam material.

The substantially coherent absorbent structure may further include particulate material. The particulate material may be distributed throughout the substantially coherent absorbent structure (e.g., throughout the matrix of fibrous material). Alternatively and/or additionally, the particulate material may be provided as one or more discrete layers of the substantially coherent absorbent structure.

The flexible, liquid permeable cover may be a nonwoven web of fibrous material. For example, the cover may be selected from spunbond webs, meltblown webs, bonded-carded webs, hydraulically entangled webs and combinations of one or more of the same. The fibrous material used to form the cover may be any suitable material. Desirably, the fibrous material is a polyolefin such as, for example, polypropylene, polyethylene, propylene copolymers, ethylene copolymers, and blends or mixtures of one or more of these materials. In an aspect of the invention, the nonwoven web or cover material may be apertured and/or treated to enhance liquid permeability or wettability. For example, surfactant treatments, chemical etching, burning, corona discharge treatments or the like may be used. Portions of the cover may be impermeable, particularly in regions where reinforcing members are added for additional strength, though desirable about 50% or more of the surface area of the cover remains substantially permeable, more specifically about 80% or more, and more specifically still about 90% or more of the surface area of the cover remains substantially permeable.

Of course, it is contemplated that the cover may be a textile material such as a woven or knit material. The cover may also be a liquid permeable film such as, for example, a slit film or an apertured film.

Desirably, the cover will have sufficient strength so the absorbent pad can be used to wipe up liquid. For example, the cover may have desirable levels of abrasion resistance and/or tear strength so it may withstand frictional forces encountered during wiping or even scouring. The cover may comprise multiple layers of materials, such as a layer for rapid intake of liquid adjacent to a second layer for strength or containment of particles. Additional elements can be attached to the cover for a variety of purposes, particularly reinforcing elements for strengthening The cover and securing mechanical fasteners. Reinforcing elements can be strips, bands, or patches of materials such as nonwoven webs, textiles (including but not limited to burlap, cotton cloth, or the like), plastic films, rubber, thermoplastic tabs or plates, tapes (including strips of tape comprising polymer films or fibers), or the like. Reinforcing elements may be attached to the cover by any means known in the art, including by adhesives, thermal bonding, ultrasonic bonding, stitchbonding, rivets, or the like. Desirably, the reinforcing elements are attached to the cover adjacent to mechanical fastening means in regions of anticipated elevated mechanical stress in the cover when the absorbent article is wetted, thus better distributing mechanical stresses and reducing the chances of the cover failing in use. Desirably, the reinforcing elements do not substantially interfere with the liquid intake performance of the cover. Desirably, the reinforcing elements are liquid permeable and/or wettable with respect to the targeted liquid.

Elastic bands and strips attached to the cover may be used to maintain shape and enhance positioning of the elongate pad next to a moist surface or to provide extensibility and stretch to the cover for improved fit.

According to the invention, fastening or attachments means may be positioned on the liquid permeable cover. The attachment means may be mechanical fasteners (e.g., Velcro® hook and loop fasteners, eyes and hooks, snaps, strings, magnetic strips or the like). Desirably, the attachment means is an adhesive layer.

The fastening means may be located on at least a portion of the liquid permeable cover. For example, the fastening means may be located on one or more portions of the cover that correspond to one or more sides of the elongate, substantially coherent, absorbent structure. When the fastening means is or includes an adhesive layer, the adhesive layer may be substantially continuous or may be substantially discontinuous. Desirably, the adhesive layer is a pressure sensitive adhesive layer. In one embodiment of the present invention, the adhesive strip has a width or thickness sufficient to provide satisfactory adhesion to a surface such as, for example, a floor, a wall, a section of a machine, pipe or tank, another absorbent pad, or a device for wiping up spills. Desirably, the adhesive layer runs along the entire length dimension of at least one side of the cover (i.e., at least one portion of the cover corresponding to a side of the substantially coherent absorbent structure).

In one aspect of the present invention, the flexible, liquid permeable cover extends beyond the ends of the absorbent structure by an amount sufficient so that two or more absorbent pads may be joined in series by adhering or fastening the extension of one pad to a portion of the cover on an adjacent pad. The extensions of the cover may also be used to create a seal between the end of an absorbent pad and an adjacent wall or structure.

The present invention encompasses an elongate, liquid absorbent pad for collecting liquid spills and leaks, the pad including: (1) a substantially coherent, liquid absorbent structure formed of a matrix of fibrous material having a substantially polygonal cross-section, a specific gravity of less than about 0.055, and a gram-per-gram liquid absorbency of greater than about 10; and (2) a flexible, liquid permeable cover enclosing the absorbent structure and having extensions beyond the ends thereof. For example, the substantially coherent, liquid absorbent structure may have a specific gravity of less than about 0.04. As another example, the substantially coherent, liquid absorbent structure may have a gram-per-gram liquid absorbency of greater than about 15. As yet another example, the substantially coherent, liquid absorbent structure may have a gram-per-gram liquid absorbency of greater than about 20.

The substantially coherent, liquid absorbent structure may be made of the materials as described above and have the general configurations described above. The flexible, liquid permeable cover may also be formed of the materials described above and have the features and attributes described above.

The present invention also encompasses a system for collecting liquid leaks and spills. The system involves:

(1) providing an elongate, liquid absorbent pad including;

a substantially coherent, liquid absorbent structure formed of a matrix of fibrous material having a substantially polygonal cross-section;

a flexible, liquid permeable cover enclosing the coherent absorbent structure and having extensions beyond the ends thereof, and;

a fastening means on at least a portion of the liquid permeable cover; and

(2) securing the elongate, liquid absorbent pad to a surface utilizing the fastening means so that the liquid absorbent pad is configured to collect/control liquid leaks and spills.

The system includes securing the elongate, liquid absorbent pad to another elongate, liquid absorbent pad utilizing the fastening means. The system also includes securing the elongate, liquid absorbent pad to a device for wiping up liquid or moving the absorbent pad into the liquid.

These and various other advantages and features of novelty which characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a perspective view illustration of an exemplary liquid absorbent pad.

FIG. 2 is a perspective view illustration of an exemplary liquid absorbent pad.

FIG. 3 is a cross-sectional view illustration of an exemplary liquid absorbent pad.

FIG. 4A is a cross-sectional view illustration of an exemplary liquid absorbent pad.

FIG. 4B is a cross-sectional view illustration of an exemplary liquid absorbent pad.

FIG. 5 is a cross-sectional view illustration of an exemplary liquid absorbent pad.

FIG. 6 is an illustration of a detail of an exemplary liquid absorbent pad.

FIG. 7 is an illustration of a detail of two exemplary liquid absorbent pad joined in series.

FIG. 8 is an illustration of a detail of an exemplary liquid absorbent pad.

FIGS. 9-17 are illustrations of exemplary applications for one or more liquid absorbent pads.

FIGS. 18-21 are graphical representations of results of performance tests of absorbent products.

### DETAILED DESCRIPTION

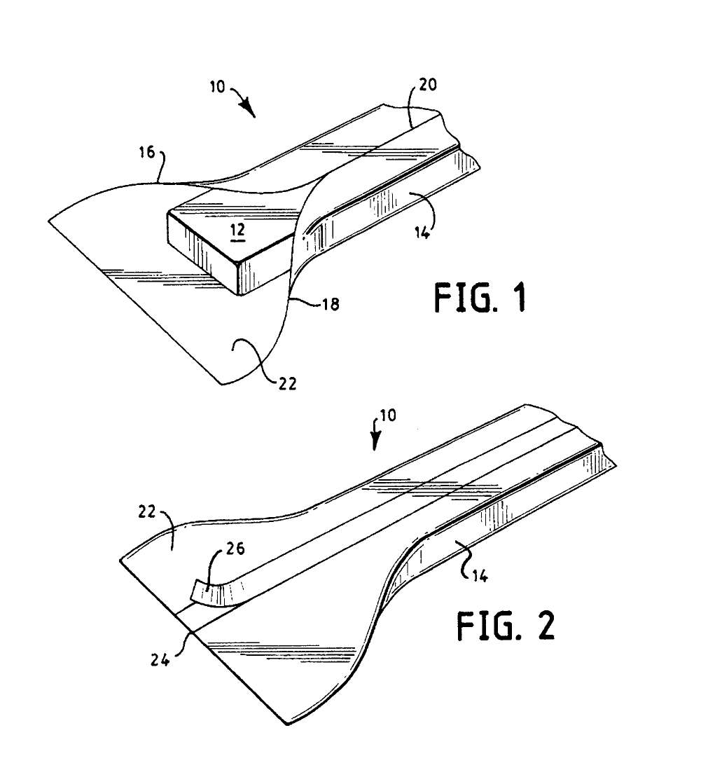

Referring now to the drawings, wherein like reference numerals designate corresponding structure throughout the views, and referring in particular to FIG. 1 there is shown a perspective view of an exemplary elongate, liquid absorbent pad 10 for collecting liquid spills and leaks. In FIG. 1, the pad 10 is partially opened up to reveal its construction. The pad includes a substantially coherent, liquid absorbent structure 12 formed of a matrix of fibrous material having a substantially polygonal cross-section.

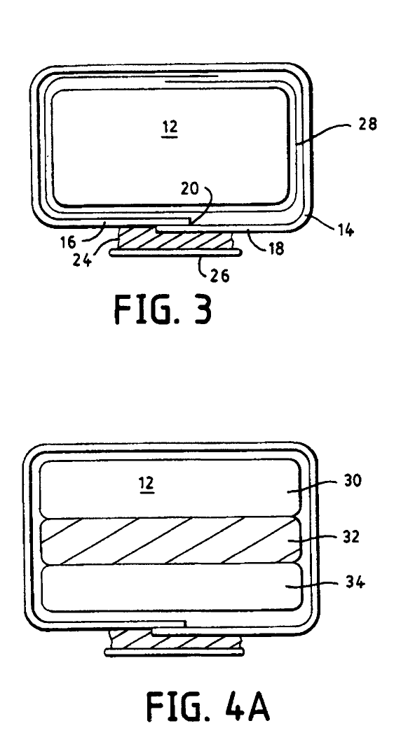

The pad 10 includes a flexible, liquid permeable cover 14 enclosing the substantially coherent absorbent structure 12. A first end 16 and a second end 18 of the flexible cover 14 are joined by a seam 20. As noted above, FIG. 1 depicts the flexible cover 14 partially opened up and having portions, tabs, or extensions 22 running beyond the ends of the coherent absorbent structure 12. Referring now to FIG. 2, a fastening means in the form of an adhesive layer 24 covered by a peal strip 26 (shown partially removed) is desirably included on at least a portion of the liquid permeable cover 14. It should be noted that FIG. 2 is a bottom perspective view of FIG. 1 in which the pad 10 and flexible cover 14 is partially opened up to reveal an exemplary construction.

The substantially coherent, liquid absorbent structure 12 is a matrix of fibrous material which may be a coherent batt of fibrous material. For example, the structure 12 may be a coherent mat of any suitable fibrous material. The coherent mat may be formed utilizing conventional fiberizing, carding, air-forming, felting, and/or similar operations. If the fibrous material lacks sufficient coherence, various adhesives, binding materials or the like may be added to provide a batt that has the required integrity, openness, resiliency so it is able to resist collapse during use.

As an example, rotating disc fiberizers, forming drums and pulp chambers of conventional pulp fluff batt forming operations may be used to form the coherent batt of fibrous material. An exemplary felting machine is described in U.S. Pat. No. 1,961,272, issued Jun. 5, 1934, to H. R. Williams. An exemplary fiberizing method and apparatus for fiberizing wood pulp fibers is described in U.S. Pat. No. 3,475,791, issued Nov. 4, 1969, to C. A. Brewster et al. An exemplary method and apparatus for forming fiber fluff is described in U.S. Pat. No. 3,755,856, issued Sep. 4, 1973 to C. T. Banks. The contents of these patents are incorporated herein by reference in their entirety.

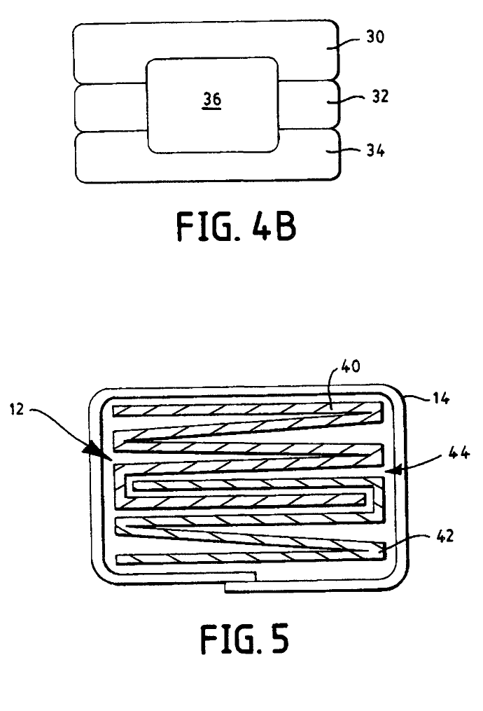

During formation of the matrix of fibrous material (e.g., the substantially coherent fibrous mat), fibers may be deposited on a carrier sheet or wrapper which can be included in the absorbent pad. For example, FIG. 3 is a cross-section of an exemplary absorbent pad revealing a substantially coherent, liquid absorbent structure 12 in the form of a coherent, generally homogeneous batt of fibrous material. The coherent batt 12 is enclosed by a wrap 28 (optional) located beneath the liquid permeable cover 14.

An adhesive seal 20 may be used to join a first edge 16 and a second edge 18 of the liquid permeable cover 14 to secure the cover around the entire structure. Of course, any suitable technique may be used to join the first edge 16 and the second edge 18 of the liquid permeable cover 14 together. Exemplary techniques include, but are not limited to, ultrasonic bonding, thermal bonding, mechanical fastening, stitchbonding, and/or combinations of the same. FIG. 3 also depicts the adhesive layer 24 and peelable strip 26 overlaying the seam 20 instead of being on the opposite side of the pad 10 as the seam 20 as in FIGS. 1 and 2.

Various fibrous materials may be used to form the matrix of fibrous material. Suitable materials include, but are not limited to pulp fluff, cotton fibers, cotton linters, synthetic fibers, as well as various manufacturing waste materials that contain fibers and/or fibrous materials. These fibers may be individualized (separated into individual fibers) or combined/agglomerated in clumps. An advantage of the present invention is that these materials may be used individually, blended together, or blended with other materials and still provide a matrix of fibrous material having satisfactory levels of strength, integrity, resilience and resistance to collapse. It is desirable that the fibrous material has an average length ranging from about 1 millimeter up to about 7 millimeters. While other fiber lengths may be satisfactory, these lengths appear to provide matrices with good strength and integrity. It is also desirable that the fibrous material have an aspect ratio ranging from about 20 to about 3500. For example, the fibrous material may have an aspect ratio of from about 20 to about 500. As yet another example, the fibrous material may have an aspect ratio of from about 20 to about 100.

Alternatively and/or additionally, the substantially coherent absorbent structure may be formed of discrete layers of fibrous material. These discrete layers may be separately formed in one or more web or batt forming process and overlaid or overlapped to form the absorbent structure.

The substantially coherent absorbent structure may further include particulate material. The particulate material may be distributed throughout the substantially coherent absorbent structure. The distribution of particulate material within the absorbent structure may be generally uniform or the distribution may define a gradient. Alternatively and/or additionally, the particulate material may be provided as one or more discrete layers of the substantially coherent absorbent structure. Suitable fibrous and particulate materials include, but are not limited to, the materials listed in TABLE 1. The bulk density and gram per gram absorbency ratio for water, mineral oil, linseed oil and 30-weight non-detergent motor oil of the various materials are given. In addition, the number of gallons of 30-weight non-detergent motor oil absorbed per pound of absorbent material is given.

TABLE 1
ABSORBENCY TEST
(GRAM PER GRAM)

| | | | | | | Motor oil |
|---|---|---|---|---|---|---|
| Absorbent | Bulk Density | Water | Mineral Oil | Linseed Oil | Motor Oil | Gallon/lb. |
| Saw Dust, Treated with Oil | 0.4008 | 0.00 | 0.85 | 0.87 | 0.83 | 0.1158 |
| Papermill Sludge, Pelletized | | 1.92 | 1.10 | 1.29 | 1.29 | 0.1800 |
| (Owensboro - 42% inorganic | | | | | | |
| Clay, Granular (commercial oil sorbent) | 0.5283 | 0.50 | 1.41 | 1.24 | 1.41 | 0.1967 |
| Papermill Sludge, Flash Dried (Coleshill - | 0.2022 | 3.18 | 2.28 | 2.97 | 3.16 | 0.4408 |
| 50% inorganic) | | | | | | |
| Corn Cob, Treated with polyvinyl | 0.1300 | 7.42 | 3.81 | 4.41 | 4.60 | 0.6417 |
| alcohol (New Pig ™ Gray) | | | | | | |
| Vermiculite, Treated with polyvinyl | 0.1270 | 6.38 | 5.31 | 5.47 | 4.86 | 0.6780 |
| alcohol (New Pig ™ Blue) | | | | | | |
| Papermill Sludge, Flash Dried | 0.1726 | 3.80 | 4.35 | 5.32 | 5.53 | 0.7714 |
| (Owensboro- 42% inorganic) | | | | | | |
| Sphagnum Moss (Sphag Sorb ®) | 0.1269 | 0.00 | 5.29 | 5.11 | 5.82 | 0.8119 |
| Kenaf (whole stalk) | 0.1488 | 7.86 | 5.23 | 6.26 | 6.41 | 0.8942 |
| Kenaf (core) | 0.1300 | 8.54 | 5.23 | 6.82 | 6.70 | 0.9347 |
| Papermill Sludge, Flash Dried (New | 0.0968 | 10.66 | 6.94 | 7.90 | 8.42 | 1.1746 |
| Millford- 6% inorganic) | | | | | | |
| Fern Pad mfg waste (Hammermilled- | 0.0547 | 13.10 | 10.33 | 11.59 | 13.00 | 1.8135 |
| ¼ in screen) | | | | | | |
| Unbonded polypropylene, Fluff- | 0.0499 | 14.60 | 12.90 | 15.60 | 13.50 | 1.8833 |
| polyvinyl alcohol treated fill (3M Yellow) | | | | | | |
| unbonded polypropylene, Fluff (3M | 0.0432 | 0.00 | 12.45 | 13.25 | 13.85 | 1.9321 |
| White) | | | | | | |
| Softwood BCTMP (Creher milled from | 0.0524 | 18.19 | 15.15 | 13.94 | 14.47 | 2.0186 |
| bale) | | | | | | |
| Polypropylene, Shred Treated (New Pig | 0.0449 | 23.00 | 12.80 | 14.80 | 16.20 | 2.2599 |
| Pink) | | | | | | |
| Fern Pad (Virgin SSWK Pulp + | 0.0296 | 23.00 | 12.80 | 14.80 | 16.20 | 2.2599 |
| debonder + antistat) | | | | | | |
| Fern Pad mfg waste (Hammermilled- | 0.0496 | 11.23 | 11.22 | 12.50 | 16.56 | 2.3101 |
| 3/16 in screen) | | | | | | |
| Fern Pad mfg waste (Hammermilled- | 0.0564 | 13.44 | 12.50 | 13.06 | 16.78 | 2.3408 |
| ⅛ in screen) | | | | | | |
| Fern Pad mfg waste (Hammermilled- | 0.0525 | 14.36 | 16.19 | 14.52 | 18.30 | 2.5529 |
| ½ in screen) | | | | | | |
| Chopped DRC waste (cellulose and | 0.0394 | 18.20 | 18.76 | 17.31 | 21.14 | 2.9490 |
| latex) | | | | | | |
| Softwood BCTMP (Pallman milled from | 0.0410 | 19.74 | 16.79 | 20.36 | 23.23 | 3.2406 |
| bale) | | | | | | |
| Polypropylene, (3M Yellow) (cover | 0.0412 | 23.90 | 21.70 | 23.30 | 23.90 | 3.3341 |
| only) | | | | | | |
| Softwood BCTMP (never baled) | 0.0259 | 20.30 | 24.70 | 25.00 | 26.00 | 3.6270 |
| Amino Plast (Safe Harbor ™ White) | 0.0110 | 36.00 | 41.00 | 49.00 | 51.00 | 7.1145 |
| Dust Brick (70% cellulose, 30% | 0.1770 | 52.45 | 3.60 | | | 0 |
| superabsorbent dust) | | | | | | |

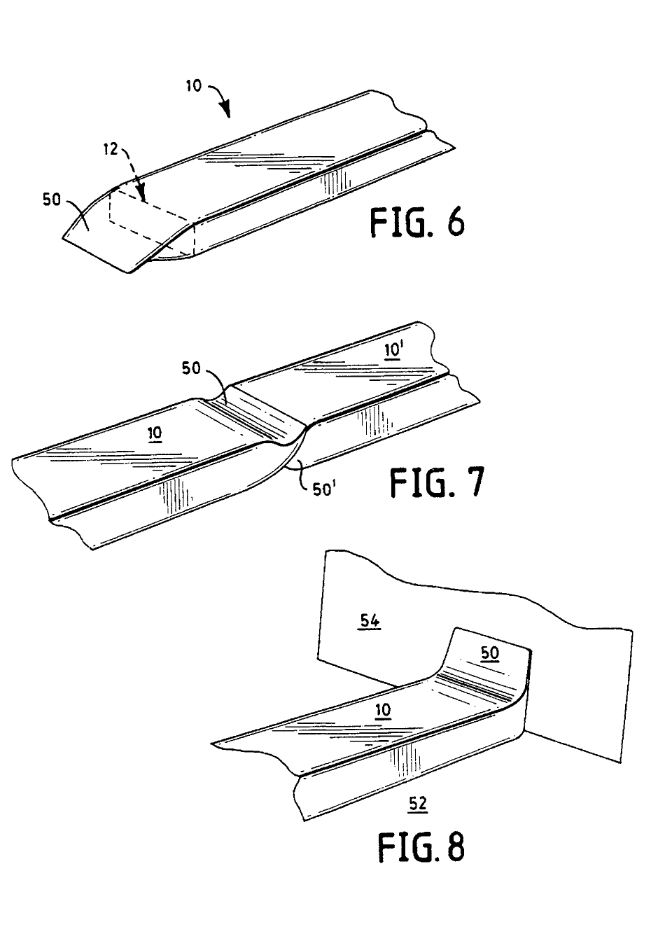

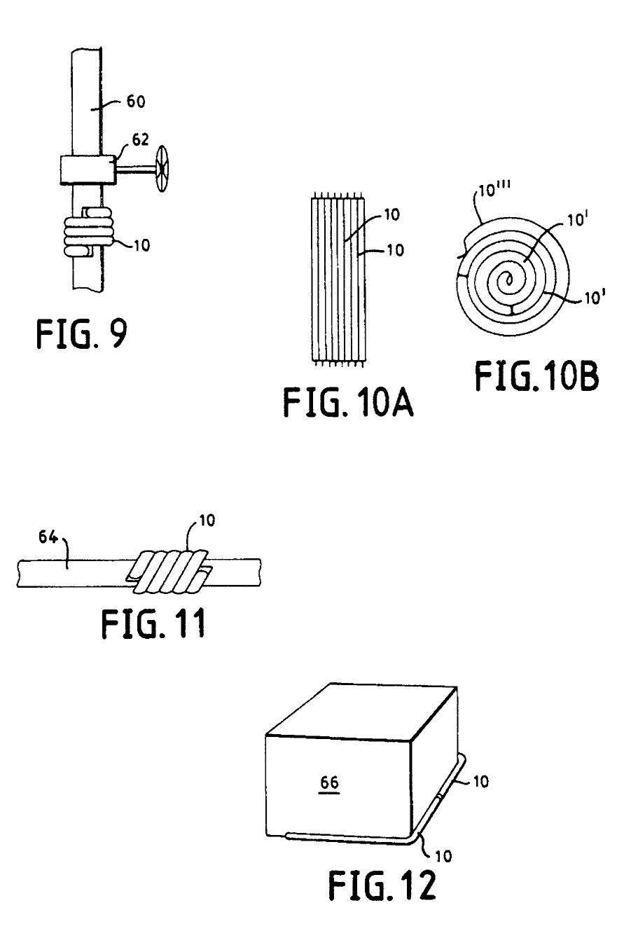

Referring now to FIG. 4A, there is shown a cross section of an exemplary absorbent pad detailing the substantially coherent absorbent structure 12 which includes a top layer 30, a middle layer 32 and a bottom layer 34. These layers are surrounded by the liquid permeable cover 14 and are shown with the adhesive layer 24 and peelable strip 26 overlaying the seam 20.

FIG. 4B is another illustration of an exemplary absorbent pad showing the substantially coherent absorbent structure 12 which includes a top layer 30, a middle layer 32 and a bottom layer 34 and a central core 36. In some embodiments of the invention, the top layer 30, middle layer 32 and bottom layer 34 are matrices of fibrous material and the central core is a zone or layer of particulate material. Such a configuration may be advantageous because the particulate material is completely enclosed by the various layers 30, 32 and 34. It is also contemplated that the central core may also be a matrix of fibrous material or may include a mixture of fibrous material and particulates.

In some embodiments of the invention, all the layers may be composed of the same or different fibrous materials. It is contemplated that some of the fibrous layers may have densities and other properties different from the other layer or layers for purposes such as, for example, to enhance absorbency, to increase uptake of liquid, to improve liquid distribution, and the like. For example, the top layer 30 may be a layer which provides rapid uptake of liquid, the middle layer 32 may be a layer with distributes liquid efficiently, and the bottom layer 34 may be a layer which has a great capacity for absorbing liquid. As another example, each layer may be made of materials that are particularly efficient at absorbing specific types of liquids. In this example, the top layer may be capable of absorbing large amounts of aqueous liquids, the middle layer may be capable of absorbing (or adsorbing) large amounts of oily liquids or non-polar liquids, and the bottom layer may be capable of absorbing and/or neutralizing caustic or acidic liquids.

It should be understood that the invention encompasses other ingredients, layers and/or additives may be added to the absorbent structure (or cover material) which have adsorbent properties, antibacterial properties, flame retardant properties, acid neutralizing properties and/or alkali neutralizing properties.

In other embodiments of the invention, one or more layers may be composed of or may include particulate materials. Exemplary particulate materials include, but are not limited to, clays, dusts, superabsorbents, pelletized sludge, ground corn cobs, vermiculite, and the like. The particulate materials may be selectively absorbent, selectively adsorbent, or have other desirable characteristics. Any number and configuration of layers is contemplated.

When particulate materials are utilized as discrete layers or by blending or mixing in the matrix of fibrous material, it is important for the absorbent structure 12 to have sufficient structural integrity so it can be considered substantially coherent. Binders, adhesives, pad wraps or the like may be used to enhance the integrity of the absorbent structure so it is substantially coherent.

Alternatively and/or additionally, the substantially coherent absorbent structure may include one or more webs such as, for example, meltblown webs, spunbond webs, bonded-carded webs, hydraulically entangled webs and combinations of these materials. For example, a single web may be gathered or folded to define a plurality of layers. As another example, several webs may be layered, gathered, and/or folded to define a plurality of layers.

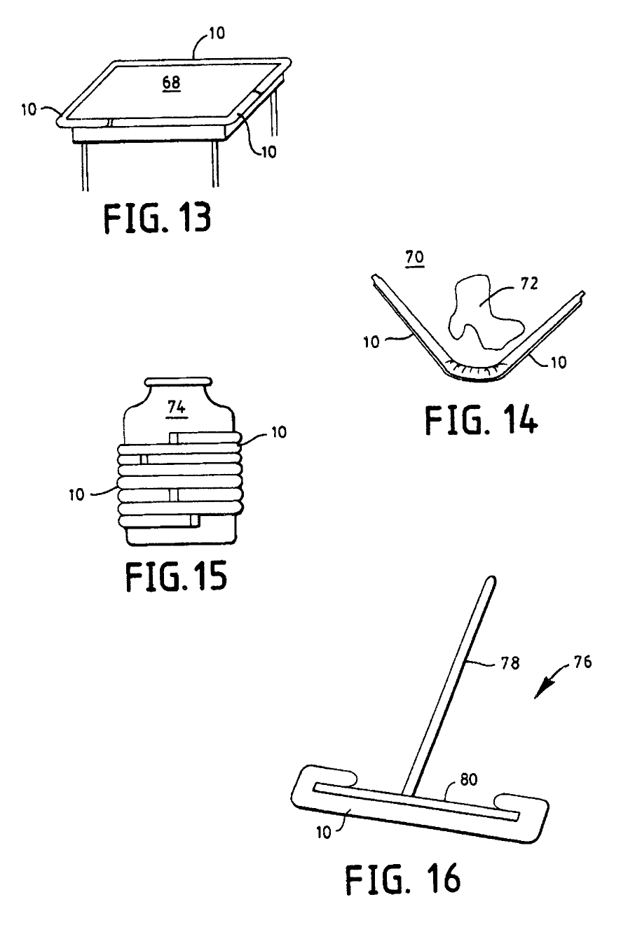

Referring now to FIG. 5, there is shown (not to scale) a cross section of an exemplary absorbent pad detailing a substantially coherent absorbent structure 12 that is formed of multiple fibrous webs. The absorbent structure is enclosed in a flexible cover material 14 and is composed of a first folded web 40 and a second folded web 42. The first folded web 40 and the second folded web 42 are inter-folded at a contact point 44, However, such an interfolded configuration is optional.

In other embodiments of the invention, the absorbent structure 12 may include layers of a coform web or may be composed entirely of a coform web or coform batt. A coform web/batt may be a matrix of meltblown fibers and at least one other material (e.g., fiber or particulate) integrated into the meltblown fiber matrix. Coform webs/batts are produced utilizing techniques described at, for example, U.S. Pat. No. 4,100,324, issued July 1978 to Anderson et al.; and U.S. Pat. No. 5,350,624, issued Sep. 27, 1994 to Georger et al., the contents of these patents are incorporated by reference in their entirety.

The absorbent structure may include adsorbent materials including activated carbon, zeolites, baking soda, activated silica, adsorbent clays and the like. The adsorbent material may be blended with, agglomerated in, or adhered to the fibrous material that forms the absorbent structure. The adsorbent material may be incorporated in a web that may be incorporated into the absorbent structure. For example, a single web including adsorbent material may be gathered or folded to define a plurality of layers and/or several webs may be layered, gathered, and/or folded to define a plurality of layers. Suitable adsorbent webs are described at, for example, U.S. Pat. No. 5,571,604 to Sprang et al. et al., the contents of which is incorporated by reference in its entirety. The absorbent structure can also comprise agents for neutralizing toxic chemicals or other harmful agents that may be present in a spill. For example, it may comprise agents for neutralizing acids such as baking soda or any known buffer or base. It may also comprise agents for neutralizing bases. The absorbent structure may comprise encapsulated chemicals in shells that dissolve, break, or degrade when in contact with the agent that the enclosed chemicals are intended to neutralize. For example, acid neutralizing agents can be encapsulated in capsules that degrade at low pH, while alkali neutralizing agents can be present in shells that degrade at low pH, such that a single absorbent structure can serve to neutralize either acid or base spills. Of course, absorbent structures can be targeted to neutralize either acids or bases only. The absorbent structures may also comprise antimicrobial agents.

An important feature of the invention is that the substantially coherent, liquid absorbent structure is elongate and has a substantially polygonal cross section. The expression “elongate” is used to mean that the absorbent pad has a length of at least about 12 inches. Desirably, the absorbent pad has a length of about 20 to 60 inches. It is contemplated that the absorbent pad could be many meters long, such as about 10 meters or greater, more specifically about 20 meters or greater, so it may be stored on a large supply roll and cut no size for a specific application.

The requirement that the structure have a “substantially polygonal cross section” means the plane of the cross section should have at least four sides (i.e., a quadrilateral cross section). Desirably, the substantially coherent, liquid absorbent structure has a substantially rectangular cross section. Such a cross-section is desirable because it provides a greater product height to hold or control liquid and a larger “footprint” or base for attachment and stability than radial cross-sections. A rectangular cross-section also has flat surfaces which help prevent the pad from being displaced, especially when used with an adhesive layer or strip. Cross-sections defining more than four sides are contemplated in the practice of the present invention. However, too many sides begin to approximate an undesirable radial cross-section.

Another important feature of the present invention is that the absorbent structure 12 is “substantially coherent”. This means the structure has sufficient integrity and strength to be relatively self-supporting and flexible so that it is capable of defining a substantially polygonal cross-section independently of the cover material. Desirably, the structure has sufficient integrity and strength so that it is generally capable of defining a substantially polygonal cross-section even during use. It is desirable that the structure have an openness, flexibility and resiliency to provide desirable levels of absorption and to resist, reduce or minimize collapse during use. This may be accomplished utilizing a mat or batt which includes fibers that are intertwined and mechanically entangled to exhibit the necessary coherence. Alternatively and/or additionally, adhesives, binder fibers, water, compression, heat or types of binder treatments may be used. The coherence of the absorbent structure should be understood in contrast to loose fibers, granules or particulates that must be supported by a cover, jacket, sleeve which is used to define or establish the cross-section of the article. For example, products that can be described as a tubular sock filled with clay particles, corn-cobs or polypropylene tow filaments or fibers utilize the tubular sock to define or establish the cross-section of the article. As another example, products that can be described as a tubular casing made of a thermoplastic fiber web heat-molded into a triangular shape and filled with granular solid matter utilize the heat-molded web to define and establish, the cross-section of the article.

According to the present invention, the flexible, liquid permeable cover 14 may be any suitable material including, for example, textile materials, knit materials, nonwoven fabrics and/or films. Desirably, the cover is a nonwoven web of fibrous material. For example, the cover may be selected from spunbond webs, meltblown webs, bonded-carded webs, hydraulically entangled webs and combinations of one or more of the same. The fibrous material used to form the cover may be any suitable material. Desirably, the fibrous material is a polyolefin such as, for example, polypropylene, polyethylene, propylene copolymers, ethylene copolymers, and blends or mixtures of one or more of these materials. The cover may also be a liquid permeable film such as, for example, a slit film, an apertured film, a porous film, a microporous film, or a microapertured film. In an aspect of the invention, the nonwoven web or cover material may be apertured and/or treated to enhance liquid permeability. For example, surfactant treatments, chemical etching, burning, corona discharge treatments or the like may be used. These treatments may be used to enhance the permeability of various types of liquids, individually or collectively. For example, such treatments may be adapted to enhance the permeability of the cover to aqueous liquids, non-aqueous liquids (e.g., oils, greases, non-polar liquids), acids, bases, suspensions, emulsions, gels or the like.

As discussed above, an adhesive seal and/or mechanical fastening means may be used to join a first edge 16 and a second edge 18 of the liquid permeable cover 14 to secure the cover around the absorbent structure. Conventional adhesives and adhesive joining techniques may be readily adapted to the construction of the present absorbent pad by persons of skill in the art. Exemplary adhesives include, but are not limited to, hot-melt garment construction adhesives used in the manufacture of personal care products (e.g., diapers, incontinence products, feminine care products) such as those available under the designations: DF-5610; 434-5563; 34-5606; I34-5551; 34-5582; IL-88; 34-5561; I716; and 518-3312 from National Starch, Bridgewater, N.J. Other suitable hot-melt construction adhesives are available under the designation D-9105; D-3950; D-8370; JM-1004-A; and D-9105-ZP from HB Fuller, St. Paul, Minn. Even more suitable hot-melt construction adhesives are available under the designation L-8507; L-8007; H-2457; H-1091 from Ato Findley Inc., of Wauwatosa, Wis. It is desirable that these adhesives adhere securely and have a bonding strength greater than or equal to the strength of the flexible, liquid permeable cover material.

Exemplary mechanical fastening techniques include stitching, stitchbonding, needlepunching, crimping or the like. Stitchbonding techniques are described at, for example, are techniques are disclosed at, for example, U.S. Pat. No. 4,891,956, issued Jan. 9, 1990, to Strack et al., the contents of which are incorporated by reference in their entirety.

In an embodiment of the invention, the cover may be made of a suitable material that can be bonded to itself by application of heat, ultrasonic energy, or an appropriate solvent so that the edges of the cover may be joined together. As an example, opposite edges of a film or nonwoven web having a thermoplastic polymer component may be joined together by applying heat and/or ultrasonic energy and pressure so that the edges securely bond or weld together. Suitable webs and techniques are disclosed at, for example, U.S. Pat. No. 5,573,841, issued Nov. 12, 1996 to Adam et al., the contents of which is incorporated by reference in its entirety.

In one embodiment of the invention, the first and second edges of the cover are wrapped around the absorbent structure and are sealed with construction adhesive by running a bead or spray pattern along the length of one edge of the cover and overlapping or overlaying the other edge so it contacts the adhesive and forms a secure adhesive bond. The remaining unbonded, terminal portions of the cover may be joined together utilizing thermal or ultrasonic bonding techniques.

According to the invention, desirable liquid permeable cover materials having good levels of flexibility are nonwoven webs of spunbonded polypropylene filaments available from Kimberly-Clark Corporation, Roswell, Ga. These spunbonded materials may have basis weights ranging from about 0.4 to about 4 ounces per square yard (osy). For example, these materials may have basis weights ranging from about 0.4 to about 2 osy. As another example, these materials may have basis weights ranging from about 0.6 to about 1 osy. Nonwoven webs including multicomponent spunbonded filaments (e.g., bicomponent spunbonded filaments) may be used. Such multicomponent filaments may have, for example, a sheath/core or a side-by-side configuration.

Shaped fibers including, but not limited to, bi-lobal, tri-lobal and multi-lobal fibers may be included in or may make up the cover materials when the absorbent pad is to be used for wiping, scouring, scarifying, cleaning or and for the removal of a spill or leak of a viscous, tar-like and/or gooey substance. Lobed fibers, shaped fibers, ribbon-like fibers and fabrics incorporating the same are disclosed at, for example, U.S. Pat. No. 5,498,468, issued on Mar. 12, 1996 to Blaney, the contents of which are incorporated by reference.

Desirably, the cover will have sufficient strength so the absorbent pad can be used to wipe up liquid. For example, the cover may have desirable levels of abrasion resistance and/or tear strength so it may withstand frictional forces encountered during wiping or even scouring. This may be accomplished by utilizing a cover material such as, for example, a nonwoven web of spunbonded filaments, having sufficient basis weight and/or bonding so the cover has the required strength and abrasion resistance yet has adequate flexibility. Suitable cover materials include, but are not limited to, nonwoven webs of spunbonded filaments/fibers having a basis weight of greater than about 0.4 osy (ounces per square yard) and/or a bond surface area of greater than about 10 and about 20 percent (as determined by conventional optical image analysis techniques). Another important factor affecting the strength of the nonwoven web is the fiber/filament diameter. Desirably, the nonwoven webs include filaments/fibers have a diameter great enough to provide sufficient levels of strength while retaining desirable drape and flexibility. Desirably, the fibers/filaments have a diameter ranging from about 10 to about 60 micrometers. More desirably, the fibers/filaments have a diameter ranging from about 17 to about 35 micrometers.

In an aspect of the invention, it is desirable that the absorbent pad has a suitable level of bursting strength. That is, the strength of the flexible cover material and the bonds joining the first edge and second edges together as well as the bonds sealing the terminal portions of the absorbent pad should be sufficient to withstand an applied force without popping open or bursting. This feature may be important if the absorbent pad is scuffed, scraped, bumped, or stepped before use, during use, or during collection for disposal. Suitable levels of bursting strength may vary depending on how the absorbent pad is to be used. Generally speaking, the bursting strength should, at a minimum, be able to withstand the peeling force of any adhesives that might be used to adhere the absorbent pad to a surface. Desirably, the bursting strength may be several times greater than the level needed to withstand the peeling force of any adhesive used to secure the absorbent pad to a surface.

Another feature of the present invention is that fastening means (e.g., mechanical fastening systems and/or adhesive layer) may be positioned on at least a portion of the liquid permeable cover. For example, the fastening means may be located on one or more portions of the cover that correspond to one or more sides of the elongate, substantially coherent, absorbent structure. To illustrate this point, reference is made to FIGS. 1 and 2 where the fastening means in the form of an adhesive layer 24 may be on the opposite side of the absorbent pad 10 as the seam 20 created by joining the first edge 16 and second edge 18 of the flexible, liquid permeable cover 14. Alternatively, as shown in FIGS. 3 and 4, the fastening means in the form of an adhesive layer 24 may be on the same side of the absorbent pad 10 as the seam 20 created by the edges of the flexible cover 14. The fastening means (e.g., adhesive layer) 24 may be positioned along a central portion of the flexible cover as shown in FIG. 2 or it may be set near or at an edge of the flexible cover. When the fastening means is an adhesive layer and utilizes an active or tacky adhesive, a peel strip should be used to cover the adhesive until the adsorbent pad is ready to be applied to a surface. Of course, the adsorbent pad may be used without removing the peel strip. Generally speaking, the peel strip may be any paper, plastic or similar sheet material which is releasable from the adhesive. The peel strip may be coated or impregnated with a conventional release agent so it may be removed without damaging the adhesive.

The fastening means may be mechanical fastening means. Such devices typically are composed of two parts which can be joined together. A first part is connected to or contained in or on the absorbent pad, while the second part resides on or adjacent to the target surface where liquid is encountered. The second part may be integral with the surface to be contacted (as is the case for attachment by magnetic means where the second part is the surface itself) or may be attached to the target surface or any other object through other mechanical or adhesive means. For example, in the case of hook and loop structures the loop component may be integral with the pad cover and may form the first part of the mechanical fastening means while a strip of hook material is the second part of the mechanical fastening means and may be attached to the target surface or any other object by means of; (1) adhesives or glues; (2) by another hook and loop structure as when a two-sided strip of hook material bridges two pads having loop material on the outer cover or when a strip of hook material engages a carpet or textile surface; (3) by clamping or pinching; (4) by nails, screws, staples or other mechanical fastening means; or (5) by tying or sewing the strip to the surface to be contacted and the like.

In an embodiment of the invention, the second part of the mechanical fastening means, such as a strip of hook material designed to engage loop material on the outer cover of the absorbent pad, may be attached to a surface where leaks are likely while the surface is dry and adhesive attachment or other attachment means are easily implemented. When leaks occur the second part of the mechanical fastening means is already in place to receive the first part of the mechanical fastening means integral with or fixedly connected to the absorbent pad. This method permits easy and rapid attachment of the pad to the leakage area and permits multiple pads to be attached to and removed from a single second pad of the mechanical fastening means. This is especially desirable when the spill or leak involves agents that may interfere with fresh attachment of an adhesive strip to the wetted surface (i.e., most fluids may interfere with adhesive attachment) and is especially desirable for regions where a high strength attachment is needed such as on a vertical surface or when the pad must be suspended from a surface or in any other condition in which gravitational or other body forces or shear forces may act to move the pad or disrupt the seal it forms with the target surface.

The second part of the mechanical fastening means is desirably flat and unobtrusive and does not interfere with the utility of the device or surface to which it is attached yet provides a reusable means for rapid attachment of absorbent pads when needed. The fastening means may be small-scale hook and loop structures such as Velcro™ fasteners, magnetic strips or other magnetic means to join the pad to iron steel or other magnetic materials, eyes and hooks wherein a plurality of large eyes desirably greater than 2 mm in diameter) are joined to the pad to permit engagement to appropriately spaced and sized hooks or other projections on a surface and the like.

According to the present invention, it is particularly desirable to use mechanical fastening systems that have hook and loop structures such as Velcro™ fasteners wherein the loop component is the liquid permeable cover enclosing the liquid absorbent structure and the hook structure may be two-sided strips of hook material to readily join two pads. It is contemplated that the fastening system may include one-sided strips of oil-resistant hook material with a satisfactory (e.g., oil-resistant) adhesive backing to enable one or more strips of hook material to be connected to a desired location where the pad may be attached later. In such an embodiment, the adhesive is desirably protected with a strip of release paper.

Mechanical fastening systems may utilize two part fastening systems such as clips, snaps, hook and loop structures or the like in which a first part is attached to or integral with the absorbent pad (e.g., loop material on the outer cover of the pad) and a second part is connected to or integral with the target surface (e.g., a hook material glued to a surface). Early attachment of a part of the mechanical fastening system (e.g., the hook material) to target locations where leaks are likely can be done while the target surface is dry to permit easy attachment of pads after leaks begin. In that case, that portion of the fastening system (e.g., the hook material) may be attached with durable glues or adhesives that can resist the leaking fluid and withstand repeated mechanical strain or with permanent or semi-permanent mechanical fastening means such as screws. Permanent attachment of the second part of the mechanical fastening means to areas where regular leaks or spills are likely such as near large equipment or hydraulic devices or near areas where oils and other liquids are handled is also especially desirable.

In an embodiment of the invention, the mechanical fastening systems may be magnetic strips. These may be elongated and are desirably flexible arrangements of high-Gauss magnetic materials such as rare-earth magnets which can attach to steel or other ferrous materials with sufficient force to hold a wetted pad in place preferably even on an oily vertical surface. According to an aspect of the invention, the magnetic strip may be a reusable, removable component which slides into an elongated pocket in the pad before use to permit attachment to a ferrous structure and which then permits removal of the strip when the pad is to be discarded. The strip is desirably flexible to permit arrangement in various forms for best fit to complex surfaces. Discrete magnets joined in a continuous plastic or rubber matrix can provide the desired flexibility.

Of course, the present invention encompasses fastening means in which one or more mechanical fastening systems and adhesives may be used separately or together. The presence of both an adhesive strip and mechanical fastening means in a pad gives added options in terms of how the pads can be attached or placed. On one preferred embodiment the mechanical fastening means or systems are not on the same side of the pad as the adhesive strip thus permitting a first pad to be adhesively attached to a surface while other pads may be joined to the first pad to form a resilient stack of pads or to allow a pad to firmly connect to two orthogonal surfaces simultaneously as in a corner.

The present invention encompasses embodiments of the absorbent pad in which the fastening means is solely in the form of adhesive layers or strips at a plurality of locations on the pad. For example, fastening means (e.g., adhesive layers) may be positioned on both the top and bottom of the absorbent pad, one or both edges or sides of the absorbent pad and/or any combination thereof. According to the invention, the adhesive layer may be a continuous layer or it may be discontinuous. The adhesive may be applied in any configuration including a continuous bead, various spray patterns, spatterings, printings, swirl arrangements or the like.

Desirably, the adhesive layer is a pressure sensitive adhesive layer. Suitable pressure sensitive adhesive include, but are not limited to, hot-melt “garment” adhesives of the type applied to personal care products (e.g., feminine care pads, incontinence products, etc.) to adhere the product to the garment of a wearer. As an example, useful hot-melt garment adhesives include those available under the designations 34-5602 (also known as “Easy Melt”); DF-5575; 170-3902; DM-523; 34-5516; 34-5512; MQ 7987; 53-4503 from National Starch, Bridgewater, N.J. Other useful hot-melt garment adhesives include those available under the designations HL-8141; D-58; D-3944; HL-8112; HM-5717; HL-1375; and HM-1972 from HB Fuller, St. Paul, Minn., and the adhesive available under the designation 910-373 from Ato Findley, Inc., of Wauwatosa, Wis.

In embodiments of the invention, the garment adhesives should provide a level of adhesion that less than the bond strength of the seam 20 which joins the first edge 16 and the second edge 18 of the cover material 14 together. While the level of adhesion may be varied and adjusted greatly, in some embodiments it is desirable that the “garment” adhesives provide a level of adhesion that may be measured in the range of about 20 to about 1000 grams for a cotton fabric or nylon fabric substrate generally in accordance with ASTM E 171-87. For example, the “garment” adhesives desirably provide adhesion in the range of about 100 to about 500 grams. Even more desirably, the “garment” adhesives provide adhesion in the range of about 200 to about 400 grams.

In embodiments of the invention, the adhesive layer may be in the form of a strip of adhesive running along the length of the flexible cover. The adhesive layer may run along the entire length dimension of at least one side of the cover (i.e., at least one portion of the cover corresponding to a side of the substantially coherent absorbent structure).

The adhesive strip may have a width ranging from almost equal to the width of the cover to a relatively thin strand or bead. Generally speaking, the adhesive strip may have a width sufficient to provide good adhesion of the adsorbent pad to surfaces in view of the peel strength or tack of the adhesive. For example, some suitable pressure sensitive adhesives of the type used in self-sealing envelopes and the like can be applied in a strip having a width ranging from about 1 inch to about one-quarter of an inch. Another feature of the invention is that when the adhesive strip on the flexible cover material is used to secure the absorbent pad to a surface, the adhesive strip and flexible cover material are adapted to conformably and securely contact the surface. This tight contact generates a seal, harrier or block to minimize gaps, spaces, capillaries and the like and reduces leakage of liquid past the absorbent pad.

The adhesive layer should provide satisfactory adhesion of the adsorbent pad to vertical surfaces, horizontal surfaces, curved surfaces, flat surfaces or surfaces having irregular topography and/or extreme temperature. Alternatively and/or additionally, the adhesive layer should provide satisfactory adhesion so the pad may adhere to flexible surfaces, moving surfaces, reciprocating surfaces, vibrating surfaces and the like. These surfaces may he encountered in a variety of forms such as, for example, a floor, a wall, a ceiling, a section of a machine, pipe or tank, another absorbent pad, or a device for wiping up spills and/or surface contamination (e.g., grime and goo). These surfaces may also include drive shafts, transmissions, differential gear housings, reservoirs/oil pans/sumps for motors or motor vehicles. While these surfaces are predominantly non-porous surfaces, it is contemplated that the adhesive layer could be configured to provide acceptable levels of adhesion to surfaces having some porosity.

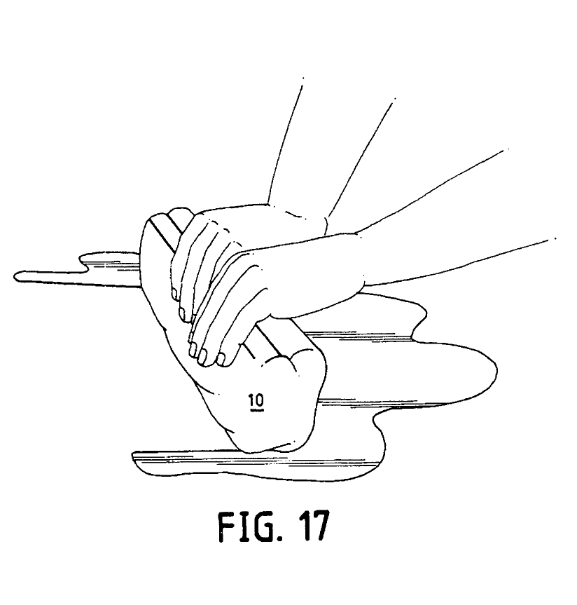

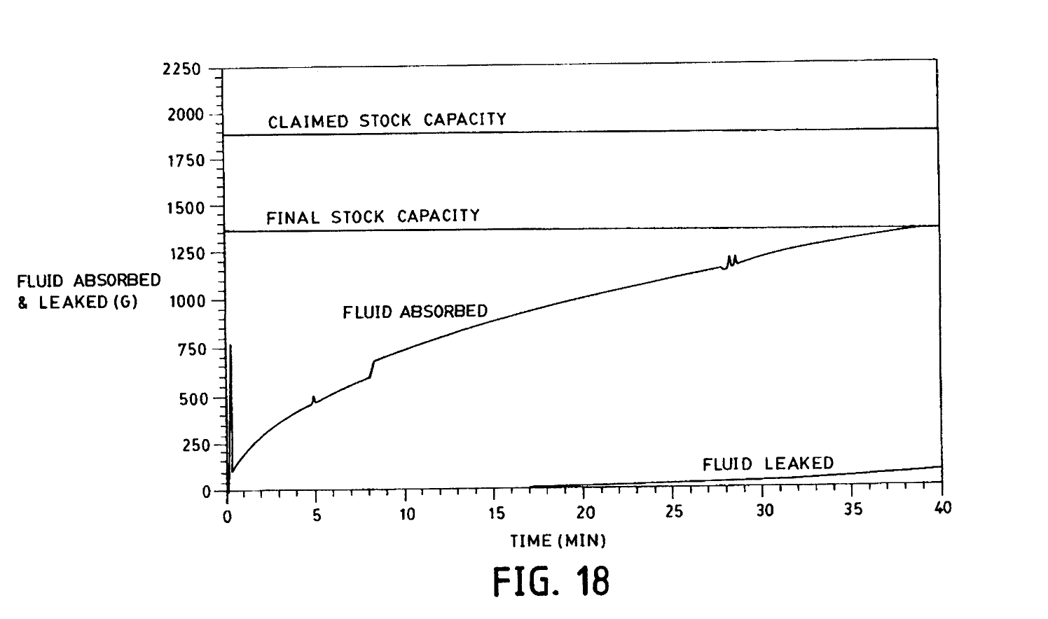

In an aspect of the present invention, the flexible, liquid permeable cover extends beyond the ends of the absorbent structure. This feature is illustrated in FIG. 6, which depicts an absorbent pad 10. The end of the absorbent structure 12 is indicated by the broken lines. A terminal portion 50 of the flexible cover 14 can be seen extending beyond the end of the absorbent structure 12. According to the invention, the length of the terminal portion 50 is desirably great enough so that two or more absorbent pads may be joined in series by adhering the terminal portion of one pad to a terminal portion of the cover on an adjacent pad. An illustration of this configuration may be seen in FIG. 7 wherein a first absorbent pad 10 and a second absorbent pad 10′ are joined in abutting relationship by overlapping the terminal portions 50 and 50′. The absorbent pads may be joined in many other configurations such as, for example, joining the terminal portion of the cover of one pad to a non-terminal portion of the cover of another pad to form a “Y”, “T”, “E” or similar pattern.

This ability to be joined in series or in various patterns provides advantages over previous absorbent products used to absorb industrial leaks and spills because the adhesive layer on the pads generates a tight seal that minimizes leakage and reduces or eliminates the need to overlap, stack or stagger extra absorbent products to catch the liquid that leaks through the locations where the absorbent products connect or through areas where gaps, spaces or capillaries are formed. The fastening means and/or the polygonal cross-section of the absorbent structure helps promote better contact between the pad and the a flat surface especially when compared to an absorbent product having a radial cross-section and no fastening means. This better contact or seal helps the present invention avoid early leakage (i.e., leakage of liquid past the absorbent product before the absorbent material has been fully utilized. This permits more efficient and economical use of the absorbent pads. Also, using fewer pads tends to reduce the amount of material to be disposed and, in, some cases, the disposal costs.

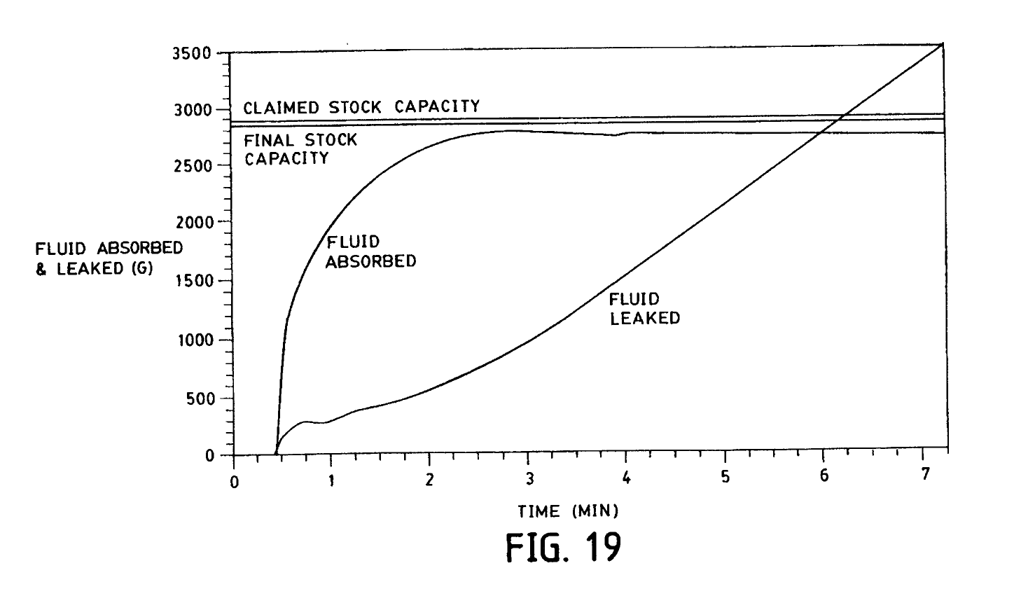

The terminal portion of flexible cover may also be used to create a seal between the terminal portion of an absorbent pad and an adjacent wall or structure as illustrated in FIG. 8. In particular, FIG. 8 shows an absorbent pad 10 on a first surface 52 and in abutting relationship with a second surface 54 that intersects the first surface 52. The absorbent pad 10 is shown adhered to the first surface 52 and the terminal portion 50 of the absorbent pad 10 is adhered tightly to the second surface 54 to create a seal or barrier to liquid. Such a seal or barrier can be used to direct liquid, control liquid flow, impound liquid, as well as to hold liquid so that it can be absorbed by the absorbent pad.

One aspect of the present invention encompasses an elongate, liquid absorbent pad for collecting liquid spills and leaks in which the pad includes; (1) a substantially coherent, liquid absorbent structure formed of a matrix of fibrous material having a substantially polygonal cross-section, a specific gravity of less than about 0.05, and a gram-per-gram liquid absorbency of greater than about 10; and (2) a flexible, liquid permeable cover enclosing the absorbent structure and having extensions beyond the ends thereof. According to the invention, the substantially coherent absorbent structure has the advantage of a relatively low specific gravity or density because it is formed of a matrix of fibrous material unlike many other products used to control leaks and spills. Generally speaking, an absorbent structure formed of a matrix of fibrous material according to the present invention and having a specific gravity of less than about 0.05 is associated with desirable levels of gram-per-gram absorbency of liquids such as oils and/or aqueous liquids.

For example, the substantially coherent, liquid absorbent structure may have a specific gravity of less than about 0.04. As another example, the substantially coherent, liquid absorbent structure may have a gram-per-gram liquid absorbency of greater than about 15. As yet another example, the substantially coherent, liquid absorbent structure may have a gram-per-gram liquid absorbency of greater than about 20.

The substantially coherent, liquid absorbent structure is made of the materials as described above and has the general configurations described above. The flexible, liquid permeable cover is also formed of the materials described above and has the features and attributes described above.

The present invention also encompasses a method or system for collecting liquid leaks and spills. The system involves:

(1) providing an elongate, liquid absorbent pad including:

a substantially coherent, liquid absorbent structure formed of a matrix of fibrous material having a substantially polygonal cross-section;

a flexible, liquid permeable cover enclosing the coherent absorbent structure and having extensions beyond the ends thereof, and;

fastening means an at least a portion of the liquid permeable cover; and

(2) securing the elongate, liquid absorbent pad to a surface utilizing the fastening means so that the liquid absorbent pad is configured to collect liquid leaks and spills.

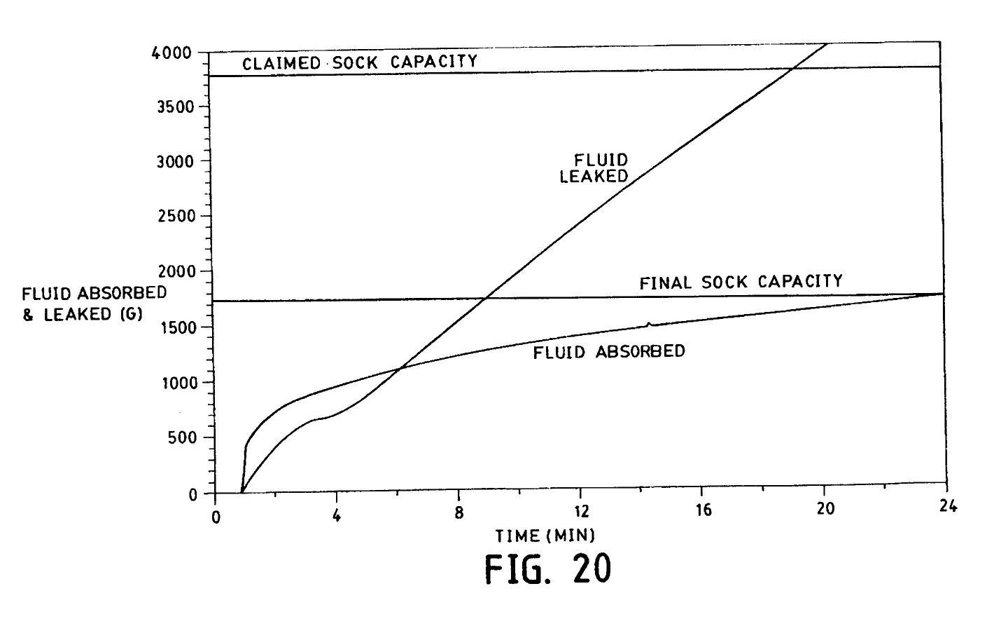

The elongate, liquid absorbent pad may be used in a variety of configurations in the practice of the present invention. For example, FIG. 9 is an illustration of an exemplary absorbent pad 10 adhered around a vertical pipe 60 so it is configured to collect liquid leaking from a valve 62. FIGS. 10A and 10B are illustrations of multiple absorbent pads 10 ganged or adhered together to function as a substitute for a drip pan. In particular, FIG. 10A is shows multiple absorbent pads 10 fastened or adhered together in parallel. FIG. 10B shows multiple absorbent pads connected in series and coiled radially. A first pad 10′ at the center is adhered to itself to form a coil. Another pad 10″ is fastened or adhered to the terminal portion and circumference of the first pad and then to itself as in is wrapped around to form a larger coil. Yet another pad 10′″ is fastened or adhered to the coil to form an even larger coil. FIG. 11 is an illustration of an exemplary absorbent pad 10 fastened or adhered around a horizontal pipe 64 so it is configured to collect liquid leaking from a pipe. Such leaks may appear at, for example, pipe joints. For purposes of the present invention, the horizontal pipe 64 in FIG. 11 is also representative of a rotating drive shaft, reciprocating shaft, vibrating shaft, flexible shaft, or other moving, vibrating, or rotating component or device. As discussed above, the absorbent pad may be adhered to such moving or movable items, FIG. 12 is an illustration of an exemplary absorbent pad 10 applied to the base of a machine 66 to absorb leaks. The absorbent pad may be fastened or adhered to the base or the pad may be positioned at the base of the machine without using the adhesive. As discussed above, the present invention encompasses absorbent pads which may be used without engaging the adhesive strip or which even lack an adhesive strip or other fastening means. The absorbent pad may also be adhered to the underside of a machine, to a moving element or component of a machine, or to other locations where conventional absorbent products without the adhesive strip would be dislodged or thrown off.

FIG. 13 is an illustration of exemplary absorbent pads 10 adhered to a work bench or working surface 68 to absorb spills. FIG. 14 is an illustration of exemplary absorbent pads 10 applied to a floor or other flat surface 70 to control a spill 72. In this embodiment, absorbent pads may be adhered or fastened to the floor or the pads may be positioned on the floor without using the adhesive. As discussed above, the present invention encompasses absorbent pads lacking an adhesive strip or pads which may be used without engaging the adhesive strip. FIG. 15 is an illustration of exemplary absorbent pads 10 applied to the exterior of a container 74 to absorb spills, splashes, or to absorb condensation which might appear on a cool or chilled container under certain conditions such as, for example, high humidity. The exemplary absorbent pads applied to a container in this manner may also be used to cushion or protect the container.

FIG. 16 is an illustration of an absorbent pad 10 adhered to an exemplary device 76 for wiping up liquids. The device 76 may be, for example, a simple “T” stick having a handle 78 and a head 80 to which one or more absorbent pads may be mechanically fastened and/or adhered. It is contemplated that in this configuration, the absorbent pad could also be used to apply liquids, to apply or remove particulate materials (e.g., dust, powders, etc.), and the like.

FIG. 17 is an illustration of an exemplary absorbent pad folded back on itself and fastened and/or adhered into position utilizing the adhesive layer so it can be used as a wad or very high capacity wiping product or liquid applicator product. In this embodiment, the absorbent pad may be hand-held. In other embodiments, the absorbent pad may be ganged together for use or may be ganged together for attachment to a stick or device for wiping-up or applying liquid.

Certain features and characteristics of exemplary absorbent pads of the present invention are illustrated by the following examples. It should be understood that these examples are illustrative only.

### Dynamic Performance Test for Absorbent Liquid and Spill Control Products

Various absorbent products were tested to simultaneously measure their ability to 1) absorb a challenge liquid (e.g., oil, acid, caustic, solvent, coolant emulsion, etc.); and 2) control or hold back a constant height of that liquid. The test was designed to simulate a real-world industrial spill situation.

In each test, the absorbent product was placed in a test tray which simulated a channel or trough. The absorbent product was laid across the open end to block the passage of liquid while being subjected to a constant height or head of liquid. Liquid leaking past the absorbent product was collected in a leakage collection tray. The rate of absorption was determined by measuring the change in the weight distribution of liquid in the testing device and applying appropriate calculations. The rate of leakage was determined by measuring the change in the weight of liquid in the leakage collection tray.

### Apparatus

Tests were conducted using a test tray having three fixed walls about 3 inches high and one open end with an adjustable/retractable wall. Absorbent products were laid across the open end of the tray. If necessary, the adjustable/retractable wall was used to accommodate the various sizes of absorbent products tested. Products tested ranged from about 20 inches to 50 inches in length. The bottom and back of the retractable wall was lined with rubber to prevent fluid leakage. The test tray was made of inert plastic, but other materials such as concrete or metal could be used to simulate different spill surface conditions.

The tray was twenty-four inches long by about fifty inches wide. Its generous size provided a large reservoir area to accommodate rapid fluid absorption with minimal changes in the challenge liquid height (Δh).

In each test, an absorbent product was placed along the open end of the tray, Prongs protruding from the open end of the tray and the side walls prevented the absorbent product from moving. To prevent preliminary fluid absorption, a thin plastic film (e.g., SARAN® wrap) was draped across the absorbent product and secured against the test tray side walls until the test tray filled to the challenge height (Δh) with liquid.

A piece of metal was attached to the base of the test tray across the entire open end to deflect leaking liquid into a leakage tray. This piece of metal extended from the base of the test tray at a 45 degree angle and for a length of about one inch toward the leakage tray.

During each test, the test tray rested on a pivot frame at approximately the center of gravity of the test tray. The pivot frame consisted of two sheets of metal joined together to form an “A” frame having a rounded, rather than pointed, apex.

The front end of the test tray rested on top of a dome (half-sphere) which, in turn, rested on an electronic balance (BALANCE A) that continually recorded the load applied to the front end of the test tray. The balance is set on a lab jack such that the height of the balance can be adjusted to ensure that the test tray is level prior to running a test. The initial loading on the balance is modified by changing the distance from the pivot frame to the balance.

The electronic balance was a Metler Balance (Model PM 4600) with RS232 output connected to a computer that recorded all data. The balance was zero-deflection balance such that as a load is applied to the balance top, an inductive coil within the balance exerts a reverse force on the balance top. Thus, despite an increase in load, the height of the balance top remains unchanged and there is no deflection in the downward direction. This is critical for maintaining the test tray constantly level during the test procedure so the electronic balance only registers a change in weight due to liquid absorbed by the absorbent product. That is, the electronic balance reading increases as the as the absorbent product absorbs liquid.

An airtight container was used to contain a reservoir of challenge fluid. The container was positioned in the center of the test tray and was designed to maintain a constant height of fluid in the test tray during a test. This was accomplished using an adjustable breather tube. One end of the breather tube extended from an airtight port at the top of the airtight container and the other, open end was mounted on a bracket to be at the desired challenge liquid height (Δh). At the beginning of a test, liquid poured out of a small opening at the bottom of the airtight container. The small opening was eventually covered up by the liquid in the test tray. After this occurred, liquid in the airtight container could exit the airtight container (and into the test tray) only if liquid was replaced by air drawn in through the breather tube. Once the level of liquid in the test tray reached the open end of the breather tube and prevented air from being drawn into the airtight container, liquid flow stopped. As liquid was absorbed by the absorbent product sample or leaked into the leakage tray, the liquid level in the test tray slightly lowered to uncover the open end of the breather tube. This simple control mechanism kept the liquid level in the test tray relatively constant.

Liquid flowing past the absorbent products is directed by the metal deflector into a leakage tray. A small tray having dimensions of about 28 inches by 1 inch was used for short absorbent products. A large leakage tray having dimensions of about 50 inches by 2 inches was used for long absorbent products. The short tray rested directly on a second electronic balance (BALANCE B) attached to a computer that recorded data so the weight of fluid in the tray could be measured directly. BALANCE B was a Metler balance similar to BALANCE A. The large tray rested on a fulcrum and an electronic balance so appropriate equations were needed to calculate the weight of liquid in the leakage tray.

### Test Procedure

The open or leakage edge of the test tray was aligned parallel to the axis of the pivot and the test tray was leveled in both the length and width dimensions. The level tray was moved until about 100 to 150 grams registers on electronic balance. The objective was to create a level tray that has a slight loading on the balance.

Next, the test sample was weighed to obtain the dry weight (to the nearest tenth gram). The open end of the test tray was adjusted to a length less than the test samples' advertised length. For example, one product having an advertised length of 42 inches (˜107 cm) was tested using a 100 cm length opening at the open or leakage end of the test tray.

The test sample was placed so its edge was in contact with the open edge of the test tray and the length dimension of the sample is parallel to the pivot. The ends of the test sample were compressed and adjusted by hand to provide the tightest fit against the vertical surfaces of the test tray. Samples having adhesive attachment means were tested using the adhesive to secure the sample against the vertical surfaces and along the open end of the test tray. Samples having loose filler material were adjusted to obtain a relatively uniform distribution of material along the length and at the ends of the sample.

The distance (d1) between center of a test sample (e.g., centroid of a tubular/cylindrical test sample) and the pivot point or line was recorded. The distance (d2) from the contact point of the balance under the test tray and pivot point or line was recorded.

A thin plastic film (e.g., SARAN® wrap) was placed over the length of the test sample to keep it from contacting the challenge liquid while the tray filled. This was accomplished by folding a piece of the plastic film along its center line to cover a 4 inch wide piece of cardboard cut to a length equal to the length of the tray opening. The film extended beyond the length of the cardboard by about 6 inches at each end.

The folded edge of the film-covered cardboard was laid along and against the bottom of the challenge/inboard side of the test sample. The lower flap of the folded film was pressed firmly against the tray surface to form a seal. The upper flap of the film was unfolded to cover the challenge/inboard side of the test sample creating a continuous barrier between the test sample and the liquid in the test tray until the film was removed. The cardboard was used to ensure full snug contact along the full length of the test sample. The extra length of film at each end of the cardboard was used to seal both vertical edges of the test tray.

A leakage tray was positioned along and below the full length of the test sample just behind the leakage deflector. The leakage tray was placed directly upon a second electronic balance if the test sample was expected to allow only a slow rate of leakage.

In cases where a rapid rate of leakage was expected, a fulcrum and balance setup was used. This fulcrum and balance arrangement was similar to that used for the test tray. The distance (d3) from the center of gravity of the leakage tray to the fulcrum and the distance (d4) from the center of gravity of the leakage tray and the balance were measured and noted.

The level of the test tray was checked and the electronic balance settings were noted. A container(s) of challenge liquid was placed in the tray so that its center of gravity was directly over the pivot line. The breather tube was set at the desired height above the surface of the test tray. Plugs in the challenge liquid containers were removed and the challenge liquid flooded the test tray.

Final adjustment to the level of the test tray were made and the electronic balance was allowed to stabilize. A balance reading was taken and was recorded as the “zero absorbed condition” for the test sample.

The computer program for recording data from the balance under the test tray and the balance under the leakage tray was started. The plastic film cover was removed lifting it vertically at each end of the test sample in a quick motion. Challenge liquid flooded against the ends of the test sample and quickly moved to the sample center. If necessary, a slight temporary pressure was applied to keep the plastic film from lifting the test tray as the film was removed. Any excess liquid on the plastic film was quickly returned to the test tray. This entire step requires about 5 to 10 seconds.

As challenge liquid is absorbed by the test sample the weight measured by balance under the test tray (balance “A”) increases. This increase can be expressed by the following equation:

(d2/d1)*(Balance A reading−Initial Balance A reading)

Liquid that that escapes the test sample is collected into the leakage tray and is represented by an increase in the reading on balance B. For test samples having a rapid rate of leaking (see, for example FIG. 20), this weight can be expressed by the following equation:

[(d3+d4)/d3] * (Balance B reading−Balance B initial reading)

For test samples having a slow rate of leaking, the weight can be expressed simply as (Balance B reading−Balance B initial reading).

Each test continued until: 1) the leakage tray was filled with liquid approximately equal to or greater than 125% of the test sample's rated capacity (e.g., 125% or 64 ounces for the gray 42-inch “original” Pig™, available from New Pig®, Tipton, Pa.); or 2) the rate at which liquid leaked past an absorbent sample equaled or exceeded the rate at which the sample absorbed liquid. The rates are measured approximately by timing the change in the two balance readings over 20 seconds.

The tests were stopped by preventing liquid from flowing out of the airtight container and then quickly removing the test sample and weighing it to confirm the accuracy of the electronic measurements. The sample was removed by holding it approximately horizontal to avoid excess leakage from it which would occur if it were to be held in vertically or if folded. Adhesively secured test samples were removed using care to avoid squeezing the test sample while detaching it from the test tray.

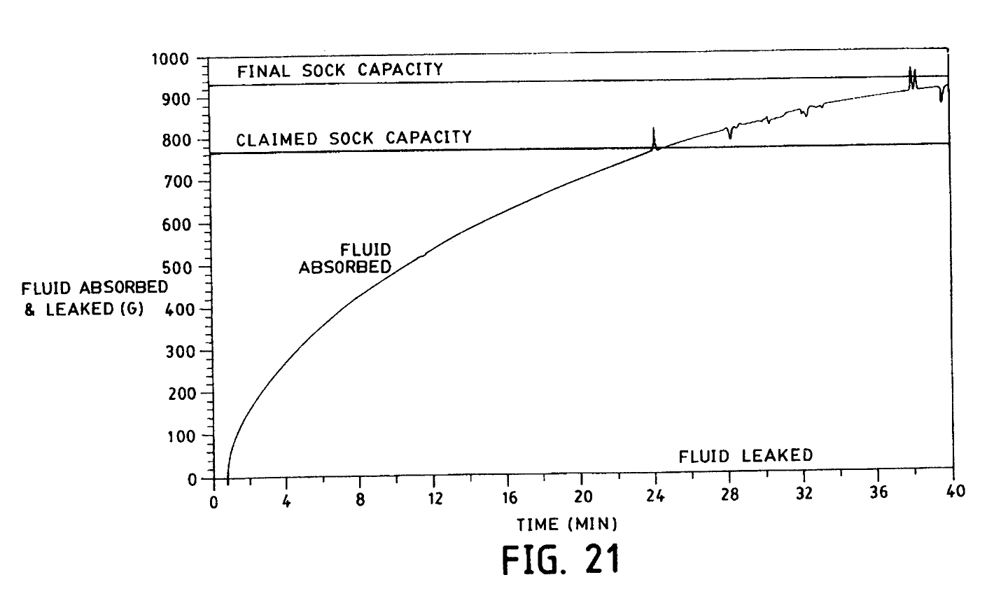

Electronic data and other measurements were used to plot a time history of the test sample performance when subjected to the challenge liquid at a constant height. Time was plotted on the X-axis and the quantity of liquid absorbed/leaked was plotted on the Y-axis. Initial readings from the balances are used to establish the “zero absorbed” and “zero leaked” condition at “time zero”. Results of the tests are shown in FIGS. 18-21.

FIG. 18 is a graphical representation of the test results of a grey-colored oil sorbent sock described as the “original” PIG™ available from New Pig™, Tipton, Pa. This product was filled with polyvinyl-alcohol-coated ground corn cobs. The challenge liquid was 30 weight non-detergent motor oil at a challenge head or height of 17 mm.

FIG. 19 is a graphical representation of the test results of a pink-colored absorbent sock described as the HAZMAT PIG™ available from New Pig™, Tipton, Pa. This product was filled with polyvinyl-alcohol-coated shredded polypropylene fibrous material. The challenge liquid was water at a challenge head or height of 13 mm.

FIG. 20 is a graphical representation of the test results of an oil sorbent sock described as the “Petroleum Sorbent Boom” available from Minnesota Mining & Manufacturing Corporation (3M), St. Paul, Minn. This product was filled with polypropylene fiber tow. The challenge liquid was 30 weight non-detergent motor oil at a challenge head or height of 13 mm.

FIG. 21 is a graphical representation of the test results of an exemplary absorbent pad of the present invention. The pad was composed of an absorbent structure that was formed of virgin pulp fibers (bleached Southern Soft-Wood Kraft [SSWK] pulp available from Weyerhaeuser, Tacoma, Wash.) plus a minor amount of a debonder and antistatic treatment. The flexible cover was a nonwoven web of spunbonded polypropylene filaments having a basis weight of about 0.4 osy (˜14 gsm). The challenge liquid was 30 weight non-detergent motor oil at a challenger head or height of 17 mm.

As can be seen in FIGS. 17-20, the present invention provides efficient absorption of liquid with very little leakage when compared to other absorbent products. It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. An elongate, liquid absorbent pad for controlling liquids, the pad comprising:
a substantially coherent, liquid absorbent structure formed of a matrix of fibrous material having a substantially polygonal cross-section;
a flexible, liquid permeable cover enclosing the substantially coherent absorbent structure and having extensions beyond the ends thereof, and;
at least one fastening means positioned on at least a portion of the liquid absorbent pad.

2. The elongate, liquid absorbent pad of claim 1, wherein the mechanical fastening means is a hook and loop fastening system.

3. The elongate, liquid absorbent pad of claim 1, wherein the mechanical fastening means utilizes a magnetic fastening system.

4. The elongate, liquid absorbent pad of claim 1, wherein the mechanical fastening means are selected from eyes, hooks, snaps, strings, clips, belts, tabs, and pins.

5. The elongate, liquid absorbent pad of claim 1, wherein the fastening means comprises an adhesive layer on at least a portion of the liquid permeable cover.

6. The elongate, liquid absorbent pad of claim 1, wherein the substantially coherent absorbent structure further includes particulate material.

7. The elongate, liquid absorbent pad of claim 1, wherein the cover is a nonwoven web of fibrous material.

8. The elongate, liquid absorbent pad of claim 1, wherein the cover is treated to enhance liquid permeability.

9. The elongate, liquid absorbent pad of claim 1, wherein the cover has sufficient strength so the absorbent pad can be used to wipe up liquid.

10. The elongate, liquid absorbent pad of claim 1, wherein the fastening means is adapted to secure the absorbent pad to a surface.

11. The elongate, liquid absorbent pad of claim 1, wherein the fastening means is adapted to secure the absorbent pad to another absorbent pad.

12. The elongate, liquid absorbent pad of claim 1, wherein the fastening means is adapted to secure the absorbent pad to a device for wiping up liquid.

13. The elongate, liquid absorbent pad of claim 1, wherein the fastening means comprises a first part attached to the absorbent pad and a second part attached to a surface where liquid is to be collected wherein the first and second part are adapted to be mechanically fastened together to secure the absorbent pad to the surface.

14. The elongate, liquid absorbent pad of claim 1, wherein the cover further comprises reinforcing elements on at least a portion of the cover.

15. The elongate, liquid absorbent pad of claim 1, wherein the substantially coherent absorbent structure includes discrete layers of material.

16. The elongate, liquid absorbent pad of claim 15, wherein the substantially coherent absorbent structure further includes particulate material.

17. The elongate, liquid absorbent pad of claim 16, wherein the particulate material is distributed throughout the substantially coherent absorbent structure.

18. The elongate, liquid absorbent pad of claim 16, wherein the particulate material is provided as one or more discrete layers of the substantially coherent absorbent structure.

19. The elongate, liquid absorbent pad of claim 1, wherein the layers of material have different functional properties.

20. The elongate, liquid absorbent pad of claim 1, wherein the absorbent pad has a length of 10 meters or greater.

21. A system for controlling liquids comprising:
providing an elongate, liquid absorbent pad comprising:
a substantially coherent, liquid absorbent structure formed of a matrix of fibrous material having a substantially polygonal cross-section;
a flexible, liquid permeable cover enclosing the coherent absorbent structure and having extensions beyond the ends thereof, and;
at least one fastening means positioned on at least a portion of the liquid permeable cover; and
securing the elongate, liquid absorbent pad to a surface utilizing the fastening means so that the liquid absorbent pad is configured to control liquids.

22. The system of claim 21, wherein the elongate, liquid absorbent pad is secured to another elongate, liquid absorbent pad.

23. The system of claim 21, wherein the elongate, liquid absorbent pad is secured to a device for wiping up liquid.

24. The system of claim 21, wherein the fastening means comprises a first part attached to the absorbent pad and a second part attached to a surface where liquid is to be collected wherein the first and second part are adapted to be mechanically fastened together to secure the absorbent pad to the surface.

25. The system of claim 21, wherein the elongate, liquid absorbent pad has a length of 10 meters or greater.
